(19) United States
(12) Patent Application Publication
(10) Pub. No.: US 2014/0188019 A1
(43) Pub. Date: Jul. 3, 2014

(54) NECK MASSAGER

(71) Applicant: Shenzhen Breo Technology Co., Ltd., Shenzhen (CN)

(72) Inventors: Xuejun Ma, Shenzhen (CN); Yong Wan, Shenzhen (CN)

(73) Assignee: Shenzhen Breo Technology Co., Ltd., Shenzhen (CN)

(21) Appl. No.: 14/148,705

(22) Filed: Jan. 6, 2014

Related U.S. Application Data
(63) Continuation of application No. PCT/CN2013/072835, filed on Mar. 19, 2013.

(30) Foreign Application Priority Data
Dec. 28, 2012 (CN) CN201210580504.6

(51) Int. Cl. A61H 15/00

(52) U.S. Cl. CPC A61H 15/0092
USPC 601/112

(57) ABSTRACT

A neck massager includes two massaging members and a connecting member connected between the two massaging members, and an upper case and a lower case being engaged to form a U-shaped housing; the two massaging members and connecting member ace disposed in the U-shaped housing; each of the two massaging members including a power component and a massaging head driven by the power component; the connecting member comprises two racks connected to the respective power component and an adjusting device configured to make the two racks contract and expand relatively. The two racks are driven to contract and expand by using the adjusting device.

### TECHNICAL FIELD

The present invention relates to massager device technical field, and more particularly, to a neck massager.

### BACKGROUND

The present neck massager mainly massages a user on the cervical vertebrae, the massager includes two massaging heads and a middle connecting member configured to connect the two massaging heads together. The middle connecting member is with elasticity, when the middle connecting member and the two massaging heads are folded inward or outward, the gap between each massaging head and the middle connecting member becomes larger or smaller. When the user using the massager, the hair of the user is clipped in the gap, thus, it is inconvenient to use. Furthermore, for the folded and adjustable massager, the long-time folded usage will affect the connecting performance between the two massaging heads and the middle connecting member.

### SUMMARY

The present invention aims at solving the problem mentioned above, the present invention provides a neck massager which is easy to use, safe and with reliable performance.

To solve the problem mentioned above, the technical solution of the present invention is to provide a neck massager including two massaging members and a connecting member connected between the two massaging members, further including an upper case and a lower case being engaged into a whole to form a U-shaped housing; the two massaging members and connecting member are disposed in the U-shaped housing; each of the two massaging members comprises a power component and a massaging head driven by the power component; the connecting member comprises two racks connected to the respective power component and an adjusting device configured to make the two racks contract and expand relatively.

Specifically, the power component is a transmission, the transmission comprises a first output shaft and a second output shaft, each massaging member comprises two massaging heads, the two massaging heads are disposed on the first output shaft and the second output shaft respectively.

Specifically, in the U-shaped housing, an upper side and a lower side of the transmission are respectively provided with a guide track, the upper side of the transmission and the lower side of the transmission are provided with a guide sleeve sleeved on the guide track.

Specifically, the adjusting device comprises: a rotation axis extending into the U-shaped housing from an outside; a knob disposed on the external end of the rotation axis; and a gear disposed on the internal end of the rotation axis, wherein the upper part and the lower part of the gear are meshed with respective rack.

Specifically, the adjusting device further comprises a locking structure for bi-directional locking disposed between the knob and the rotation axis.

Specifically, the locking structure comprises a ratchet rotated synchronously with the knob and a ratchet block engaged with the ratchet, the rotation axis is installed and fixed in a center of the ratchet.

Specifically, the ratchet block is sleeved on the ratchet, the ratchet comprises a reverse upper ratchet buckle and a reverse lower ratchet buckle, the ratchet block is provided with a upper ratchet ring and a lower ratchet ring, the ratchet tooth of the upper ratchet ring is opposite to the ratchet tooth of the lower ratchet ring, the upper ratchet buckle is matched with the upper ratchet ring and the lower ratchet buckle is matched with the lower ratchet ring.

Specifically, the ratchet comprises a body, the upper ratchet buckle and the lower ratchet buckle are disposed forward and backward along the axis of the body, the upper ratchet buckle and the lower ratchet buckle are symmetric along the radial central line of the body, the upper ratchet buckle and the lower ratchet buckle are symmetrically provided with a first installing groove, the two installing grooves are positioned on the same circumferential line, the internal side of the knob is provided with two first fixing rods disposed in the two installing grooves respectively.

Specifically, along the radial central line of the body two second fixing rod are disposed on the lower ratchet, the two second fixing rod press against the upper edge and the lower edge of the lower ratchet respectively, the internal side of the knob is provided with corresponding second installing grooves in which the two second fixing rod slide respectively when the two second fixing rod is rotated.

Specifically, a gap is defined between the upper ratchet buckle and the body and between the lower ratchet buckle and the body, the gap is curved.

In the present invention, the two racks are driven to contract and expand by using the adjusting device, the two power member is indirectly driven to get close or get away from each other, thereby adjusting the relative distance between the two massaging heads. Furthermore, the two massaging members and the connecting member are disposed in the U-shaped housing, and the U-shaped housing is a whole structure combined by the upper case and the lower case, the two massaging members is totally wrapped in the U-shaped housing, when the two massaging members move relatively, there is no gap or crack, the hair of the user won't be clipped. Compared to the present manually folding manner, in the present invention, the distance between the two massaging members 100 is adjusted by using the adjusting device. This adjusting manner is more precise and controllable, and won't hurt the performance of the connecting member even the massager is used for a long time, so the lifetime is longer.

### BRIEF DESCRIPTION OF THE DRAWINGS

FIG. 1 is a schematic structure view of a prefer embodiment of a neck massager of the present invention.

FIG. 2 is an exploded view after a pulling band is disassembled according to the embodiment of the present invention.

FIG. 3 is a cross-section view of the neck massager according to the embodiment of the present invention.

FIG. 4 is an enlarged view of A part in FIG. 3.

FIG. 5 is a structure view of a ratchet block according to the embodiment of the present invention.

FIG. 6 is a structure view of a ratchet according to the embodiment of the present invention.

FIG. 7 is a structure view of a knob block according to the embodiment of the present invention.

FIG. 8 is a schematic motion view that when the knob is rotated clockwise the connecting member drives the massaging head to move according to the embodiment of the present invention.

FIG. 9 is a schematic view when the knob isn't rotated according to the embodiment of the present invention.

FIG. 10 is a schematic motion view that when the knob is rotated counterclockwise the connecting member drives the massaging head to move according to the embodiment of the present invention.

### DETAILED DESCRIPTION OF THE PREFERRED EMBODIMENTS

For a clear purpose, technology solution and advantage of the present invention, a detailed description of embodiments of the invention is displayed hereafter in connection with the accompanying drawings. It should be understood that the detailed embodiments according to the present invention are provided for explanation only, and not for the purpose of limiting the invention.

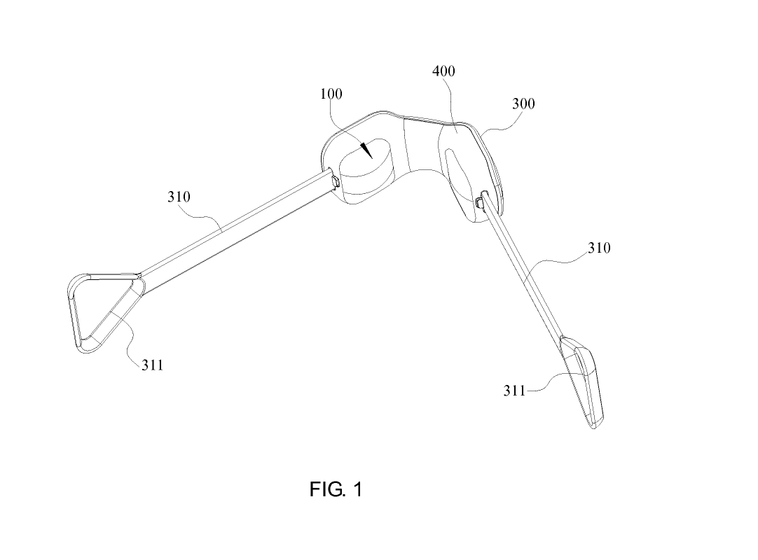

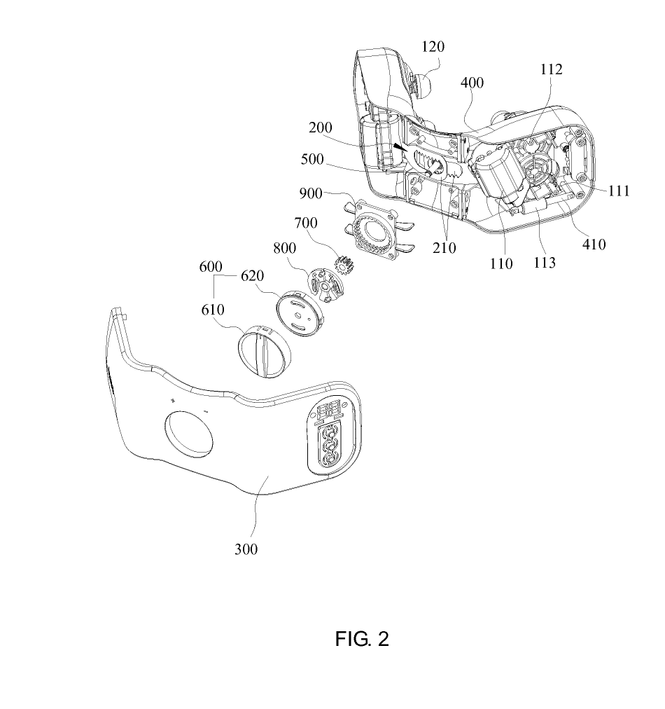

Referring to FIGS. 1 and 2, the present invention provides a neck massager comprising two massaging members 100 and a connecting member 200 connected between the two massaging members 100, further comprising an upper case 300 and a lower case 400 which are engaged into a whole to form a U-shaped housing; the two massaging members 100 and connecting member 200 are disposed in the U-shaped housing; each of the two massaging members 100 comprises a power component 110 and a massaging head 120 driven by the power component 110; the connecting member 200 comprises two racks 210 connected to the respective power component 110 and an adjusting device configured to make the two racks 210 contract and expand relatively. In the present invention, the two racks 210 are driven to contract and expand by using the adjusting device, the two power member 110 is indirectly driven get close or get away from each other, thereby adjusting the relative distance between the two massaging heads 120. Furthermore, the two massaging members 100 and the connecting member 200 are disposed in the U-shaped housing, and the U-shaped housing is a whole structure combined by the upper case 300 and the lower case 400, the two massaging members 100 is totally wrapped in the U-shaped housing, when the two massaging members 100 move relatively, there is no gap or crack, the hair of the user can not be clipped. Compared with the present manually folding manner, in the present invention, the distance between the two massaging members 100 is adjusted by using the adjusting device. This adjusting manner is more precise and controllable, and can not hurt the performance of the connecting member even the massager is used for a long time, so the lifetime is longer.

Specifically, referring to FIG. 2, in this embodiment, the power component 110 is a transmission. The transmission comprises a first output shaft 111 and a second output shaft 112; each massaging member 100 comprises two massaging heads 120. The two massaging heads 120 are disposed on the first output shaft 111 and the second output shaft 112 respectively. When respective transmission starts, the first output shaft 111 and the second output shaft 112 respectively drive the two massaging heads 120 to rotate and massage.

In this embodiment, in the U-shaped housing, specifically, in the lower case 400, the upper side and the lower side of the transmission are respectively provided with a guide track 410, the upper side of the transmission and the lower side of the transmission are provided with a guide sleeve 113 sleeved on the guide track 410. When the respective transmission is driven by the respective rack 210 to move, the guide sleeve 113 slides along the guide track 410. The match of the guide sleeve 113 and the guide track 410 guides the motion of the respective transmission, such that the motion of the transmission is more balanced and will not generate an offset.

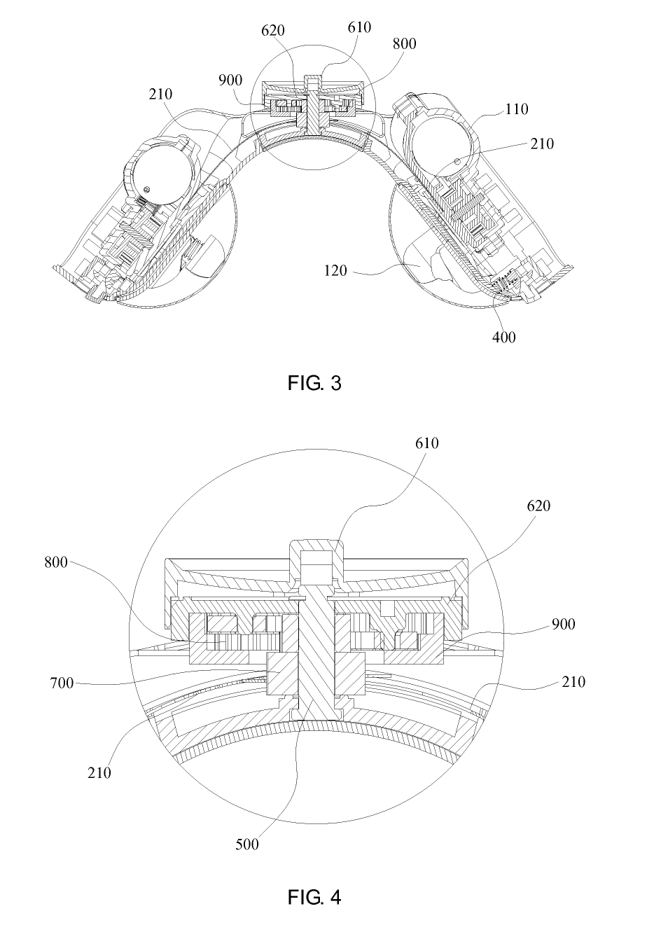

Referring to FIGS. 3 and 4, in this embodiment, the adjusting device comprises: a rotation axis 500 extending into the U-shaped housing from an outside; a knob 600 disposed on the external end of the rotation axis 500; and a gear 700 disposed on the internal end of the rotation axis 500, wherein the upper part and the lower part of the gear 700 are meshed with respective rack 210. This knob 600 comprises a knob block 620 disposed in the internal side of the U-shaped housing and a knob case 610 protruding to the external side of the U-shaped housing and fixed into a whole with the knob block 620. When the knob case 610 is rotated, the knob case 610 drives the knob block 620 to rotate and the knob block 620 drives the rotation axis 500 to rotate. The gear 700 disposed on the internal end of the rotation axis 500 is driven by the rotation axis 500 to rotate synchronously with the rotation axis 500. When the gear 700 rotates clockwise or counterclockwise, the gear 700 drives the two racks meshed with the upper part and the lower part of the gear respectively to get close or get away from each other. Because the two racks are connected with the transmission in the two massaging members 100 respectively, the two massaging members 100 is driven by the two racks to get close or get away from each other, thereby adjusting the distance to obtain a suitable distance, such that it is suitable for different user to use. Of course, the distance between the two massaging member 100 is adjusted by but not limited to the above adjusting device. The distance may be adjusted by using an overlapping setting and a corresponding active buckle manner.

Furthermore, in this embodiment, the adjusting device further comprises a locking structure for bi-directional locking disposed between the knob block 620 and the rotation axis 500. The knob block 620 and the rotation axis 500 are locked through the locking structure. When the two massaging member 100 is adjusted to obtain a suitable distance through the knob block 620, the knob block 620 is locked by the locking structure. The knob block 620 can't be rotated if it is not manual rotation. The distance between the two massaging member 100 is fixed to avoid a respective movement upon the massager; therefore it is convenient to use.

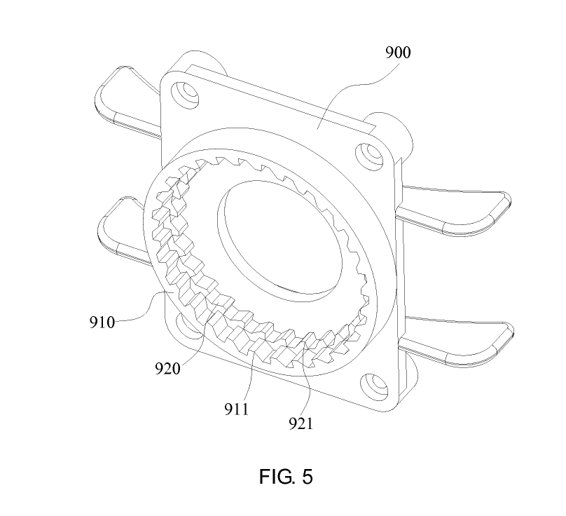

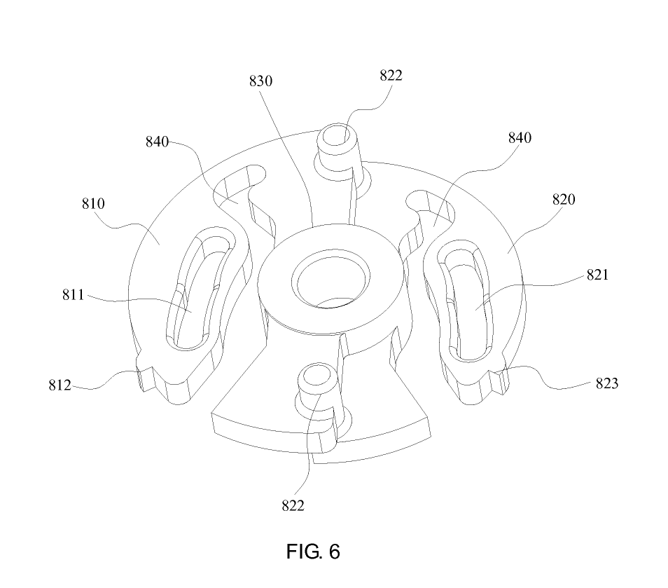

Referring to FIGS. 5 and 6, the locking structure comprises a ratchet 800 rotated synchronously with the knob block 620 and a ratchet block 900 engaged with the ratchet 800, the rotation axis 500 is installed and fixed in the center of the ratchet 800. Specifically, the ratchet block 900 is sleeved on the ratchet 800, the ratchet 800 comprises a reverse upper ratchet buckle 810 and a reverse lower ratchet buckle 820, the ratchet block 900 is provided with a upper ratchet ring 910 and a lower ratchet ring 920, the ratchet tooth of the upper ratchet ring 910 is opposite to the ratchet tooth of the lower ratchet ring 920, the upper ratchet buckle 810 is matched with the upper ratchet ring 910 and the lower ratchet buckle 820 is matched with the lower ratchet ring 920. When the knob block 620 stop being rotated, the upper ratchet buckle 810 and lower ratchet buckle 820 are engaged with the upper ratchet ring 910 and lower ratchet ring 920, such that the ratchet 800 can't rotate if there is no an external force, therefore the rotation axis 500 can't rotate and the gear 700 is fixed to ensure a respective fixture of the two racks 210.

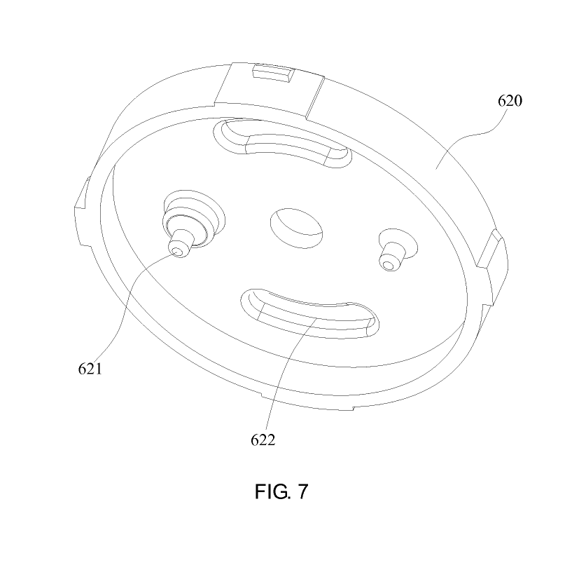

Referring to FIG. 7, the ratchet comprises a columnar body 830; the upper ratchet buckle 810 and the lower ratchet buckle 820 are disposed forward and backward along the axis of the body 830. The upper ratchet buckle 810 and the lower ratchet buckle 820 are semicircular structures. the semicircular structures are symmetric along the radial central line of the body 830, the upper ratchet buckle 810 and the lower ratchet buckle 820 are symmetrically provided with a first installing groove 811, 821, the two first installing grooves 811, 812 are positioned on the same circumferential line, the internal side of the knob block 620 is provided with two first fixing rods 621, the two first fixing rods 621 is disposed symmetrically and is disposed in the two first installing grooves 811, 821 respectively when assembled. The ratchet 800 is pulled to effectively separate with the ratchet block 900 through the matched first installing grooves 811, 821 and the first fixing rods 621.

In this embodiment, along the radial central line of the body two second fixing rod 822 are disposed on the lower ratchet 820, the two second fixing rod 822 press against the edges of the lower ratchet 820, the internal side of the knob block 620 is provided with corresponding second installing grooves 622. The two second fixing rods 822 are slidably disposed in the two second installing grooves 622 respectively when assembled. When the knob block 620 is rotated, the knob block 620 may effectively drive the ratchet 800 to rotate through the matched second installing groove 622 and the fixing rod 822.

Referring to FIG. 6, a hollow gap 840 is disposed between the upper ratchet buckle 810 and the body 830 and between the lower ratchet buckle 820 and the body 830, the gap is curved shaped. By using this gap design, the upper ratchet buckle 810 and the lower ratchet buckle 820 is with a better elasticity, and is separated with the ratchet block 900 more easily.

Referring to FIG. 5, the ratchet block 900 is provided with a hollow sleeve-shaped structure. The upper ratchet ring 910 is disposed on the outer side of the hollow internal hole of the hollow sleeve-shaped structure. The lower ratchet ring 920 is disposed on the inner side of the upper ratchet ring 910. The upper ratchet ring 910 have an upper ratchet teeth 911 of which the teeth surface on the left side is a right angle surface and the teeth surface on the right side is an inclined surface. The lower ratchet ring 920 has a lower ratchet teeth 921 of which the teeth surface on the left side is an inclined surface and the teeth surface on the right side is a right angle surface. Referring to FIG. 6, the outer edge of the upper ratchet buckle 810 is provided with a first bump 812. The outer edge of the lower ratchet buckle 820 is provided with a second bump 823. The inner surface of the first bump 812 along the circumference direction of the ratchet 800 is right angle surface; the outer surface of the first bump 812 along the circumference direction of the ratchet 800 is a circular surface. The inner surface of the second bump 823 along the circumference direction of the ratchet 800 is a right angle surface; the outer surface of the second bump 823 along the circumference direction of the ratchet 800 is a circular surface. The ratchet block 900 is sleeved on an outer side of the ratchet 800, such that the right angle surface of the first bump 812 is fastened to the teeth surface on the left side of the upper ratchet teeth 911 on the upper ratchet ring 910, the right angle surface of the second bump 823 is fastened to the teeth surface on the right side of the lower ratchet teeth 921 on the lower ratchet ring 920.

In this embodiment, two end of the U-shaped housing are provided with a pulling band 310. The pulling band is provided with a through hole 311. When the user uses the neck massager, two hands pass through respective through hole 311 and grip the through hole 311 to firmly catch the U-shaped housing, on one hand to ensure that the massaging head 120 on the inner side of the caught U-shape housing is better fit on the neck to process the massager, on the other hand to prevent a drop of the U-shaped housing from the neck upon shaking for massager because of the hand.

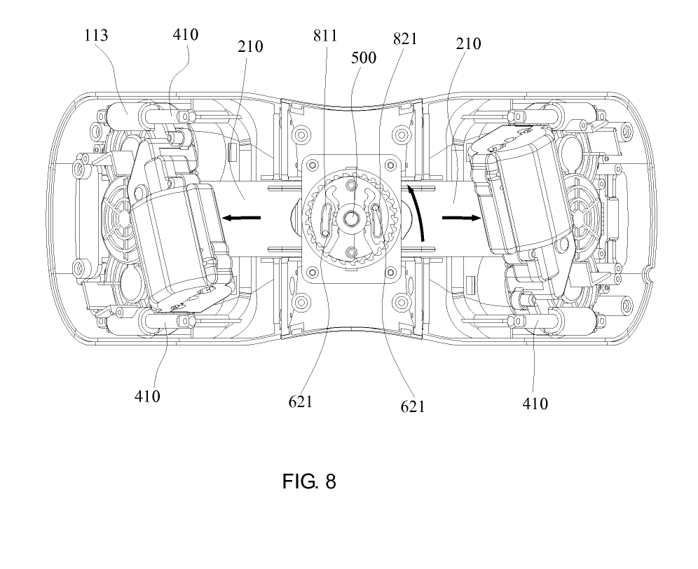

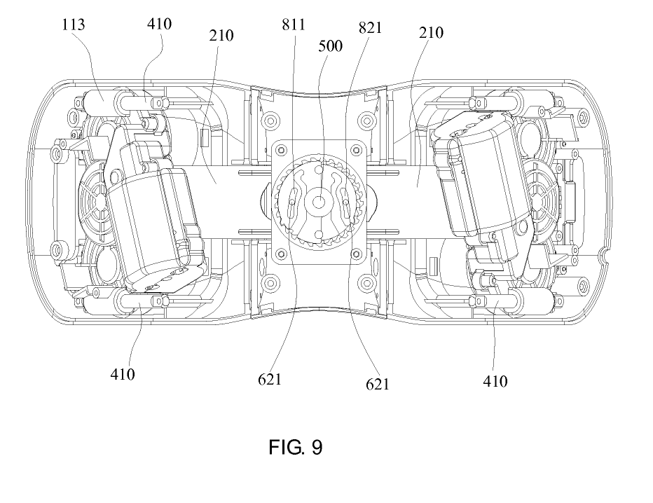

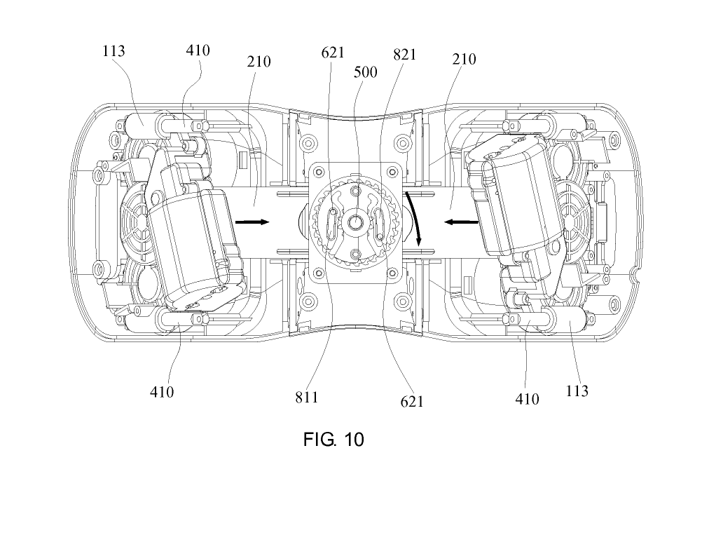

Referring to FIG. 8, when the knob case 610 is rotated clockwise, the ratchet is driven by the two fixing rods 822 and is rotated following the knob block 620. When the knob block 620 is rotated, the two connecting rods 621 on the inner side of the knob block 620 are rotated counterclockwise following the knob block 620. The connecting rod 621 in the first installing groove 811 moves downward; the connecting rod 621 in the other first installing groove 822 moves upward. Because the engaged surface of the upper ratchet buckle 810 of the ratchet 800 and the upper ratchet ring 910 of the ratchet block 900 is disposed on left side of the upper ratchet teeth. Therefore, pulled by the two fixing rods 822, the upper ratchet buckle 810 is separated with the upper ratchet teeth 911 of the upper ratchet ring 910; when the lower ratchet buckle 820 is rotated clockwise, the circular surface of the second bump 823 of the lower ratchet buckle 820 has a smooth transition with the inclined surface of the lower ratchet teeth 921 of the lower ratchet ring 920 thereby separating with the inclined surface of the lower ratchet teeth 921 of the lower ratchet ring 920. So the ratchet 800 is totally released from the limitation of the ratchet block 900 and moves to drive the gear 700 to rotate counterclockwise. Then the two racks engaged with the gear get away from each other, so the two massaging members 100 extend outward and the two massaging heads 120 get away from each other. Similarly, referring to FIG. 9, the knob case 610 stops being rotated, the first bump 812 and the second bump 823 also stop being rotated and are engaged with the upper ratchet teeth 911 and lower ratchet teeth 921 on the position where the upper ratchet teeth 911 and lower ratchet teeth 921 are located respectively. Therefore, the ratchet 800 can't rotate if there is no external force, the gear 700 can't rotate to ensure that the two racks 210 can't move outward or inward. Referring to FIG. 10, the knob case 610 stops is rotated clockwise; the two massaging members 100 get close with each other. The principal is similar with that mentioned above, it does not need to describe further.

The embodiments mentioned above is the best mode for the present invention, the present invention is not limited by the above embodiment. What described above are only preferred embodiments of the present disclosure but are not intended to limit the scope of the present disclosure. Accordingly, any modification, equivalent replacement or improvement based on the spirit and principal of the invention shall also fall within the scope of the present disclosure.

What is claimed is:

1. A neck massager comprising two massaging members and a connecting member connected between the two massaging members, wherein further comprising an upper case and a lower case being engaged into a whole to form a U-shaped housing; the two massaging members and connecting member are disposed in the U-shaped housing; each of the two massaging members comprises a power component and a massaging head driven by the power component; the connecting member comprises two racks connected to the respective power component and an adjusting device configured to make the two racks contract and expand relatively.

2. The neck massager of claim 1, wherein the power component is a transmission, the transmission comprises a first output shaft and a second output shaft, each massaging member comprises two massaging heads, the two massaging heads are disposed on the first output shaft and the second output shaft respectively.

3. The neck massager of claim 2, wherein in the U-shaped housing, an upper side and a lower side of the transmission are respectively provided with a guide track, the upper side of the transmission and the lower side of the transmission are provided with a guide sleeve sleeved on the guide track.

4. The neck massager of claim 1, wherein the adjusting device comprises:
a rotation axis extending into the U-shaped housing from an outside;
a knob disposed on the external end of the rotation axis; and
a gear disposed on the internal end of the rotation axis,
wherein the upper part and the lower part of the gear are meshed with respective rack.

5. The neck massager of claim 4, wherein the adjusting device further comprises a locking structure for bi-directional locking disposed between the knob and the rotation axis.

6. The neck massager of claim 5, wherein the locking structure comprises a ratchet rotated synchronously with the knob and a ratchet block engaged with the ratchet, the rotation axis is installed and fixed in a center of the ratchet.

7. The neck massager of claim 6, wherein the ratchet block is sleeved on the ratchet, the ratchet comprises a reverse upper ratchet buckle and a reverse lower ratchet buckle, the ratchet block is provided with an upper ratchet ring and a lower ratchet ring, the ratchet tooth of the upper ratchet ring is opposite to the ratchet tooth of the lower ratchet ring, the upper ratchet buckle is matched with the upper ratchet ring and the lower ratchet buckle is matched with the lower ratchet ring.

8. The neck massager of claim 7, wherein the ratchet comprises a body, the upper ratchet buckle and the lower ratchet buckle are disposed forward and backward along the axis of the body, the upper ratchet buckle and the lower ratchet buckle are symmetric along the radial central line of the body, the upper ratchet buckle and the lower ratchet buckle are symmetrically provided with a first installing groove, the two installing grooves are positioned on the same circumferential line, the internal side of the knob is provided with two first fixing rods disposed in the two installing grooves respectively.

9. The neck massager of claim 8, wherein along the radial central line of the body two second fixing rod are disposed on the lower ratchet, the two second fixing rod press against the upper edge and the lower edge of the lower ratchet respectively, the internal side of the knob is provided with corresponding second installing grooves in which the two second fixing rods slide respectively when the two second fixing rods is rotated.

10. The neck massager of claim 8, wherein a gap is defined between the upper ratchet buckle and the body and between the lower ratchet buckle and the body, the gap is curved.
